(19) United States
(12) Patent Application Publication
(10) Pub. No.: US 2018/0243893 A1
(43) Pub. Date: Aug. 30, 2018

(54) Safety Hammer

(71) Applicant: George John, Brampton (CA)

(72) Inventor: George John, Brampton (CA)

(21) Appl. No.: 15/445,980

(22) Filed: Feb. 28, 2017

(51) Int. Cl. B25D 1/02; B25D 1/04

(52) U.S. Cl. CPC B25D 1/02; B25D 1/04

(57) ABSTRACT

A safety hammer is provided that may be designed to prevent injuries caused by flying nails when users accidentally fail to strike nails on their heads. The present invention may provide for a wooden handle with finger grooves. The wooden handle may be reinforced with a steel rod to add strength and attach the handle to the tempered steel head. Close to the end used for striking nails, the present invention may provide for a pin configured to attach the metal shield to the end used for striking nails. The track in the shield may fit over the pin to ensure the pin is positioned correctly around the face of the present invention's hammer face. In some embodiments, the shield may be secured by magnets, which may be embedded around the present invention's hammer head. The present invention may also provide for a fulcrum point that may be oriented above the nail removal portion of the present invention.

### Cross-Reference to Related Application

This application claims priority to U.S. Provisional Application No. XX/XXX,XXX filed on Feb. 29, 2016, the disclosure of which, including any materials incorporated by reference therein, is incorporated herein by reference in its entirety.

### TECHNICAL FIELD

The present invention relates generally to the field of hammers and more specifically relates to a hammer with an attachable safety shield that fits over the end of a hammer head and can be used to strike nails.

### BACKGROUND

People rarely think about safety when using a hammer, but many accidents and injuries can occur when people are hammering and not being careful. A nail must be held carefully between one's fingers and hit squarely on its head in order to penetrate the wood straight. When nails are not into the wood far enough, the nails can fly off at unpredictable angles when they are not hit squarely on their heads. Sometimes, these uncontrolled nails can cause injuries. This is not desirable. A suitable solution is needed.

Various attempts to solve this problem have been made. One such attempt can be seen with respect to U.S. Pat. No. 6,347,562, incorporated by reference in its entirety herein, which generally discloses a safety hammer with interchangeable utility heads. While this disclosure does teach a safe hand tool, it fails to provide for an adequate adjustable shield element.

Another attempt can be seen with respect to U.S. Pat. No. 6,928,899, incorporated by reference in its entirety herein, which generally discloses a hammer with stress-distribution elements. While this disclosure does provide for a reduced recoil and associated danger, it fails to provide for adequate finger grooves, which provide stability.

Yet another attempt can be seen with respect to U.S. Patent Application Publication No. 2014/0352498 A1 incorporated by reference in its entirety herein, which generally discloses another hammer, albeit a simpler one than the previously cited disclosures. While theoretically minimizing danger to the user via this disclosure's slim design, this disclosure fails to provide for the contoured head, locking mechanism, and precise finger grooves of the present invention.

Various attempts have been made to solve the problems which may be found in the related art but have thus far been unsuccessful. A need exists for a reliable safety hammer to avoid the above-mentioned problems.

### SUMMARY OF THE INVENTION

The present invention relates to a safety hammer that overcomes the deficiencies of the prior art. It is contemplated that the present invention may provide a safety hammer that prevents nails from injuring users.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel safety hammer. The general purpose of the present invention, which will be described subsequently in greater detail, is to provide a hammer with an attachable safety shield that fits over the end of the head used to strike nails. The features of the invention which are believed to be novel are particularly pointed out and distinctly claimed in the concluding portion of the specification. These and other features, aspects, and advantages of the present invention will become better understood with reference to the following drawings and detailed description.

In one embodiment, the present invention may provide for a safety hammer that may be designed to prevent injuries caused by flying nails when users accidentally fail to strike nails on their heads. The present invention may provide for a wooden handle with finger grooves, making the present invention easier to grasp when a user is working. The present invention's wooden handle may be reinforced with a steel rod to add strength and to attach the handle to the tempered steel head. Close to the end used for striking nails, the present invention may provide for a pin, or a “pin,” useful for attaching a metal shield. A track in the shield may fit over the pin to ensure that the pin is positioned correctly around the face of the present invention's head. The shield may be further secured by magnets, which may be embedded around this or another end of the hammer's head. The present invention may be used in the same way as conventional hammers. The present invention has done away with the cumbersome claw often used for removing nails in the prior art, and has replaced this inadequate solution via a carefully designed twist on the top of the present invention's hammer portion. This may allow a user to pull nails without having to turn the present invention upside down, and may make the present invention look more aerodynamic and modern. Also, the present invention may provide for a small fulcrum point above the nail removal portion of the present invention. It is contemplated that in certain embodiments, the present invention may be available in different sizes, ranging from, by way of illustration and not limitation, four inches to seven inches.

The unique features of the present invention may provide the following benefits for one or more consumers: it may prevent many serious injuries caused by nails flying back and hitting the users or others nearby; the added safety shield may not affect the way the present invention is used; when a nail is not hit squarely, the present invention's shield may prevent the nails from flying around unpredictably.

### BRIEF DESCRIPTION OF THE DRAWINGS

These and other features, aspects and advantages of the present invention will become better understood with regard to the following description, appended claims, and accompanying figures where:

FIG. 1 shows a side perspective view of a safety hammer in accordance with one embodiment of the invention.

FIG. 2 shows a top-side perspective view of a safety hammer in accordance with one embodiment of the invention.

FIG. 3 shows an exploded view a safety hammer in accordance with one embodiment of the invention.

FIG. 4 shows a close-up exploded view a safety hammer in accordance with one embodiment of the invention.

### DETAILED DESCRIPTION

The present invention overcomes the limitations of the prior art by providing a new and more effective safety hammer.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use. It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

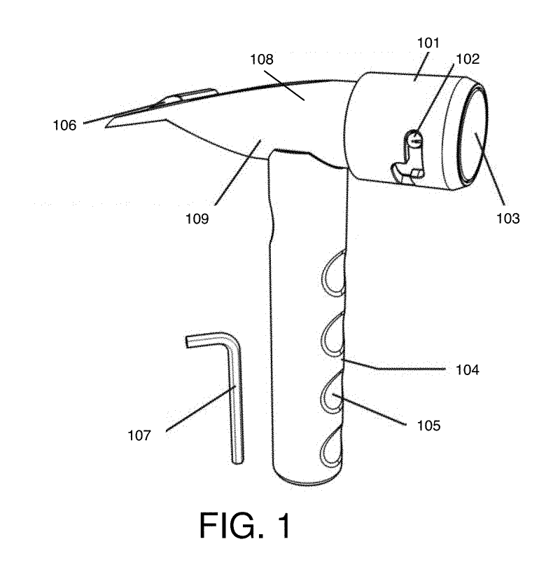

Turning attention to FIG. 1, a side perspective view of a safety hammer in accordance with one embodiment of the invention is shown. In the embodiment depicted, the present invention comprises an adjustable shield 101, a pin 102, a head 103, a handle 104, finger grooves 105, a fulcrum 106, and an alien key 107, and tail 108. It is contemplated that in some embodiments, it is contemplated that a black-oxide finish 109 may cover head 103, tail 108, or any other portion of the present invention.

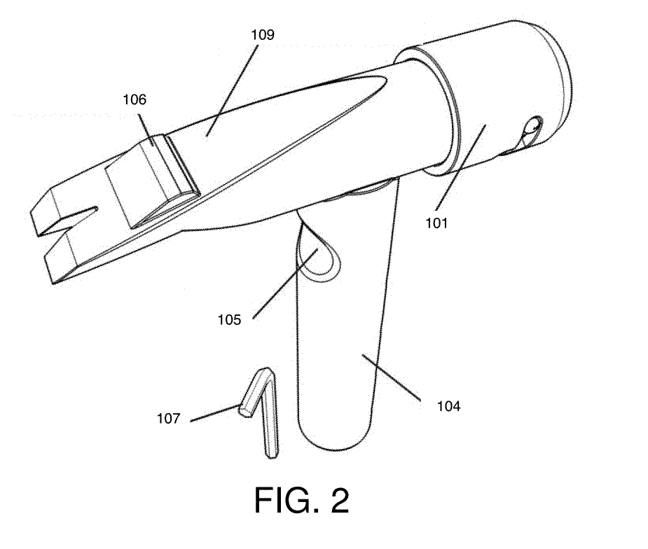

With respect to FIG. 2, a top-side perspective view of a safety hammer in accordance with one embodiment of the invention is shown. In the embodiment depicted, adjustable shield 101, finger grooves 105, fulcrum 106, handle 104, and alien key 107 may be perceived in their relative orientation to each other. It is contemplated that in some embodiments, it is contemplated that a black-oxide finish 109 may cover any portion of the present invention.

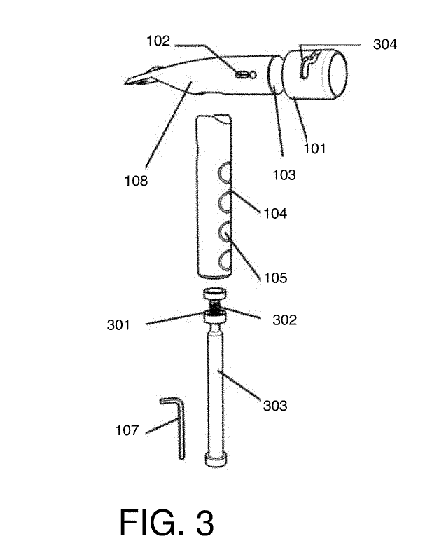

Turning attention to FIG. 3, an exploded view a safety hammer in accordance with one embodiment of the invention is shown. In the embodiment depicted, the present invention comprises an adjustable shield 101, a pin 102, a head 103, a handle 104, finger grooves 105, a fulcrum 106, and an alien key 107, and tail 108. FIG. 3 also discloses track 304, flat washer 301, screw 302, and shaft 303. It is contemplated that in some embodiments, it is contemplated that a black-oxide finish 109 (not pictured in FIG. 3) may cover any portion of the present invention.

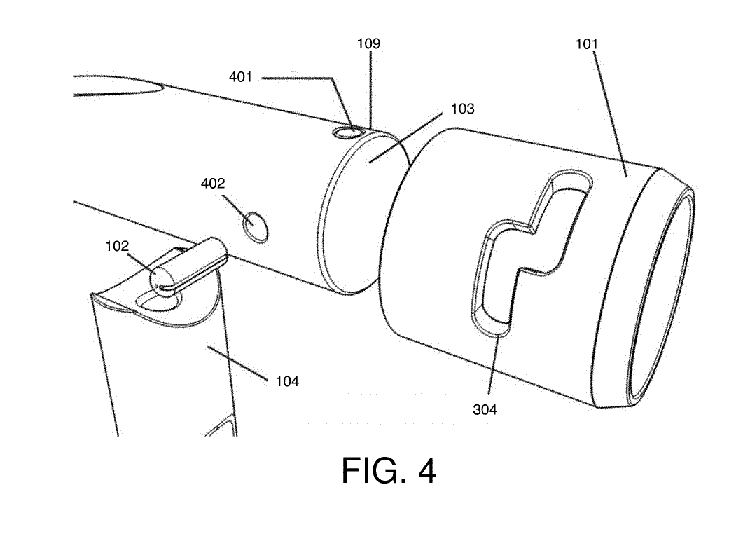

With respect to FIG. 4, a close-up exploded view a safety hammer in accordance with one embodiment of the invention is shown. In the embodiment depicted, magnet 401 and pin hole 402 are disclosed, as are adjustable shield 101, pin 102, handle 104, and track 304. It is contemplated that in some embodiments, it is contemplated that a black-oxide finish 109 may cover any portion of the present invention.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112. While the garment and method of using the same has been disclosed in connection with a number of embodiments shown and described in detail, various modifications should be readily apparent to those of skill in the art.

What is claimed is:

1. A hand tool, comprising:
a cylindrical center member having a first end and a second end;
an approximately conical end member having a head end, a tail end and a base, wherein the tail end has a midpoint and is forked;
a cavity in the conical end member's base, the cavity configured to receive the first end, wherein when the first end is inserted into the cavity, the conical end member and the cylindrical member are in orthogonal orientation relative to each other;
a safety shield configured to cover the head end, the safety shield having an opening; and
a pin member configured to extend from a side on the head member through the opening.

2. The hand tool of claim 1, wherein the cylindrical member has a plurality of grooves configured to receive one or more fingers.

3. The hand tool of claim 1, the tail end further comprising a fulcrum positioned at the forked portion's midpoint.

4. The hand tool of claim 1, wherein the opening is a track having two settings.

5. The hand tool of claim 1, wherein the opening is a track having three settings.
